(19) United States
(12) Patent Application Publication
(10) Pub. No.: US 2026/0287471 A1
(43) Pub. Date: Sep. 24, 2026

(54) GAS TURBINE TEST BENCH WITH GAS CAPTURE

(71) Applicants: SAFRAN AIRCRAFT ENGINES, PARIS (FR); SAFRAN LANDING SYSTEMS, ELIZY-VLLACOUBLAY (FR)

(72) Inventors: Caroline Marie FRANTZ, MOISSY-CRAMAYEL (FR); Franck Marc Florent SELLES, MOISSY-CRAMAYEL (FR); Bruna Manuela RAMOS, MOISSY-CRAMAYEL (FR); Marie-Laure Madeleine Yvonne DE CRESCENZO, MOISSY-CRAMAYEL (FR)

(21) Appl. No.: 19/471,795

(22) PCT Filed: Apr. 4, 2024
(86) PCT No.: PCT/FR2024/050440

§ 371 Date: Oct. 2, 2025

(30) Foreign Application Priority Data
Apr. 4, 2023 (FR) FR2303357

(51) Int. Cl. G01M 15/14; B01D 53/04

(52) U.S. Cl. CPC G01M 15/14; B01D 53/0407; B01D 2253/204; B01D 2253/342; B01D 2257/504; B01D 2258/01

(57) ABSTRACT

A gas turbine test bench includes a building which includes an air inlet stack at its first end and a gas exhaust stack at its second end, a test hall containing the gas turbine intended to be tested, and at least one pollutant gas treatment device capable of treating the gas flow which is displaced by the gas turbine during operation and which flows to the exhaust stack. The pollutant gas treatment device includes a solid adsorbent which includes at least one modular block having a plurality of channels, the walls of which are adsorbent and in which the displaced gas flow is able to flow.

The present invention relates to a gas turbine test bench. More especially, the invention relates to a turbomachine test bench comprising a system for depolluting a pollutant gas present in the gas stream displaced by this turbomachine. For example, this pollutant gas is carbon dioxide CO₂.

Such a test bench is described in document WO 2021/009226. With reference to FIG. 8, which represents the prior art, the test bench comprises, from upstream to downstream (in the normal direction of air flow) an inlet stack 181, a test hall 182, and an exhaust stack 183. The air enters the test hall 182 through the vertical inlet stack 181, which is open to the outside at its inlet. The test hall 182 comprises a turbomachine 190 which is mounted on a thrust balance 191. Downstream of the turbomachine 190 tested, there is an exhaust duct which comprises a tube 110 which is intended to receive at its inlet 111 (upstream end) the exhaust gases escaping from the turbomachine 190 during its test. This tube 110 is provided at its outlet 112 (downstream end) with a bursting basket 113 which is a cylinder closed and is downstream and by a concave cover and pierced on its side wall with holes. The exhaust gases exit the bursting basket through these holes and rise back into the exhaust stack 183 and then escape into the atmosphere.

During operation of the turbomachine, there are three air and gas flows that circulate in the test hall 182:
the primary flow (FP), which passes through the combustion chamber (HP (high pressure) core) of the turbomachine 190 and participates in combustion. This primary flow FP is therefore at the outlet loaded with carbon dioxide gas CO₂ but also with water, Sox, Nox and other particles;
the secondary flow (FS), which is compressed by the fan of the turbomachine 90 and which generates the majority of the thrust;
the induced air flow (FI), which is sucked by the negative pressure at the outlet of the turbomachine 190. In fact, the engine flow, the sum of the primary flow FP and the secondary flow FS, entering the tube 110 of the exhaust duct, causes, by jet pump effect, a so-called “induced” flow that circulates in the test hall 182 without passing through the turbomachine 190.

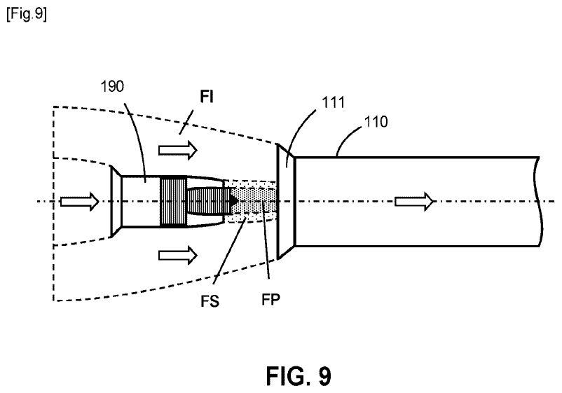

These various flows are illustrated in FIG. 9 by arrows, FIG. 9 being a longitudinal view of the turbomachine 190 and of the upstream portion of the tube 110 of FIG. 8. For the sake of clarity, the thrust balance 191 is not shown. All these flows flow in the tube 110 of the exhaust duct.

Due to combustion in the turbomachine 190, the above flows that mix and circulate in the exhaust duct comprise carbon dioxide gas that is released into the atmosphere at the outlet of the exhaust stack 183. This release of carbon dioxide is undesirable. To reduce this release into the atmosphere, and to depollute these flows, it is possible to place in the exhaust stack 183 a filtration device 170 (also called a treatment device) for the carbon dioxide gas contained in these flows. Such a filtration device 170 consists of a bed or a stack of grains of adsorbent material through which the streams to be depolluted pass. Such a device is that used in the direct capture of carbon dioxide gas in the ambient air (“Direct Air Capture” or DAC).

Thus, in general, a gas-turbine test bench is known comprising a building which includes an air inlet stack at a first end of the building and a gas exhaust stack at a second end of the building, a test hall containing the gas turbine intended to be tested, and at least one pollutant-gas treatment device capable of treating the flow of gas that is displaced by the gas turbine in operation and which flows as far as the exhaust stack.

However, the concentration of pollutant gas (of carbon dioxide in the example given above) in the flow flowing in the exhaust stack 183 is low (between 0.4% and a few percent). This characteristic makes the filtration device 170 inefficient. Furthermore, since the air flow through the filtration device 170 is great, and the operation of the test bench is discontinuous (the turbomachine test phases are separated by phases without tests), the filtration process is very energy-consuming. Furthermore, there is a pressure drop through the filtration device 170, and it is desirable to reduce this pressure drop in order to allow a correct escape of the gases in the bench during the entire test phase.

### DESCRIPTION OF THE INVENTION

The present invention aims to overcome these drawbacks.

The invention aims to propose a gas-turbine test bench in which the treatment of the pollutant gas present in the gas stream displaced by this gas turbine in operation is carried out with a minimum pressure drop through this treatment device, with optimal efficiency, and in the most economical manner possible.

This aim is achieved by virtue of the fact that the pollutant-gas treatment device includes a solid adsorbent which is made of at least one modular block having a plurality of channels the walls of which are absorbent and in which the displaced gas flow is able to flow.

Thanks to these provisions, the gas to be depolluted is able to flow more freely through the treatment device while being depolluted, and consequently the pressure drop through the pollutant-gas treatment device is reduced. This is because the channel structure with absorbent walls (rather than a structure of stacked grains) allows depollution while allowing a gas flow to flow more freely. In addition, the process of depolluting the gas stream is simplified since, thanks to the structure of the adsorbent, it is able to operate up to 85% moisture in the gas stream. Therefore, it is not necessary to use a dehumidification device upstream of the gas treatment device. Moreover, the test bench and the gas treatment device are optimized in terms of energy since it is the turbine itself that provides the suction of the gas flow during a test. Furthermore, in the case where the solid adsorbent is made up of a plurality of modular blocks, the modular-block structure of the adsorbent allows adaptation to a variety of test bench architecture. This thus reduces the costs associated with modifying the test bench.

For example, the block or blocks consist of metal substrates shaped to form the channels and a porous adsorbent material that covers the substrates.

Thus, the adsorption is more efficient and the pressure drop across the blocks is minimized.

For example, the adsorbent material is a metal-organic framework.

Thus, the adsorption is more efficient.

For example, at least two of the channels are parallel and their main axis A is oriented, at the upstream end of the channels, in the direction of flow of the displaced gas flow.

Thus, the pressure drop across the blocks is minimized.

For example, each of the channels has a cross-section selected from a polygonal cross-section and a curvilinear cross-section

For example, the surface area of the open cross-section of the at least one block is greater than or equal to 70% of the surface area of the total cross-section of the at least one block.

Thus, the pressure drop across the blocks is minimized.

For example, the treatment device includes a duct that is connected to the exhaust stack downstream of the exhaust stack and such that the adsorbent rests directly on the floor.

Thus, the incorporation of the adsorbent into the test bench building is facilitated.

For example, the test bench includes a second pollutant-gas treatment device which is located upstream of the gas turbine.

Thus, gas stream depollution is optimized.

For example, the test bench is lacking a displaced gas stream suction system separate from the gas turbine.

The invention also relates to a method for producing a gas turbine test bench which comprises a building which comprises an air inlet stack at a first end of the building and a gas exhaust stack at a second end of the building and a test hall containing the gas turbine intended to be tested.

According to the invention, the method comprises the following steps
(a) a modular block is constructed which has a plurality of channels the walls of which are absorbent.
(b) If applicable, step (a) is repeated in order to construct a plurality of the modular blocks, the at least one modular block constituting an adsorbent, with which a pollutant gas treatment device is formed.
(c) The pollutant-gas device is arranged in the test bench such that the gas flow which is displaced by the gas turbine in operation and which flows to the exhaust stack is capable of flowing in the channels.

For example, in step (b), the adsorbent consists of a plurality of the blocks which are disposed in a transverse plane perpendicular to the flow direction in the blocks to form a layer, this arrangement being repeated to form a plurality of these layers, the layers being aligned in the flow direction to form the adsorbent.

The invention will be better understood and its advantages will appear more clearly upon reading the following detailed description of embodiments shown by way of non-limitative examples. The description refers to the accompanying drawings, in which:

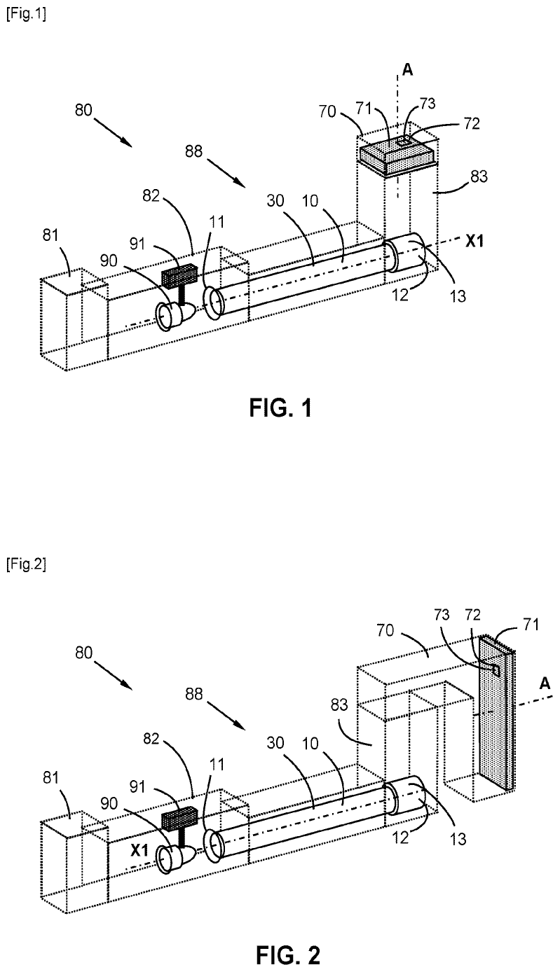

FIG. 1 is a perspective view of a gas-turbine test bench according to the invention.

FIG. 2 is a perspective view of a gas-turbine test bench according to another embodiment of the invention.

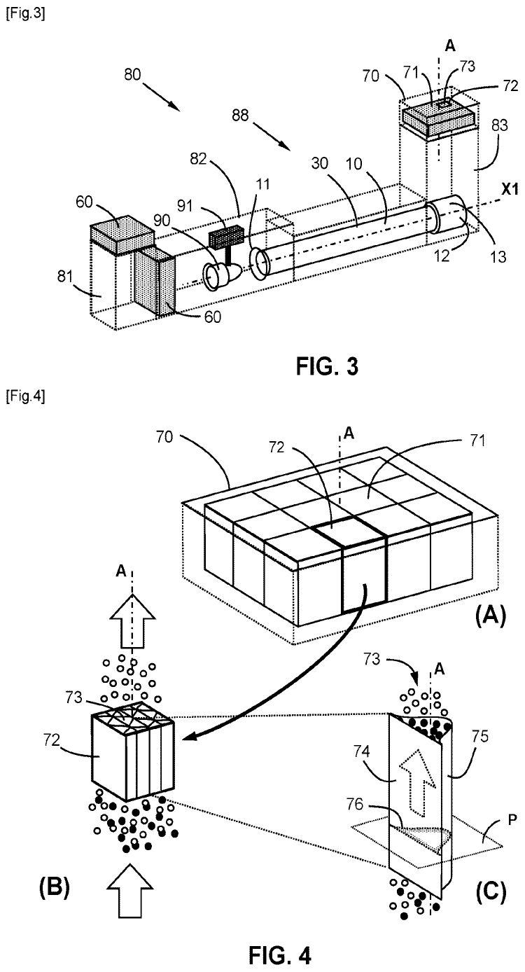

FIG. 3 is a perspective view of a gas-turbine test bench according to yet another embodiment of the invention.

FIG. 4 is, in (A) a perspective view of the structure of the adsorbent; in (B) a perspective view of a block of the adsorbent; and in (C) a schematic illustration of the adsorption mechanism in a channel of a block of the adsorbent in perspective; in the gas treatment device of a gas turbine test bench according to the invention.

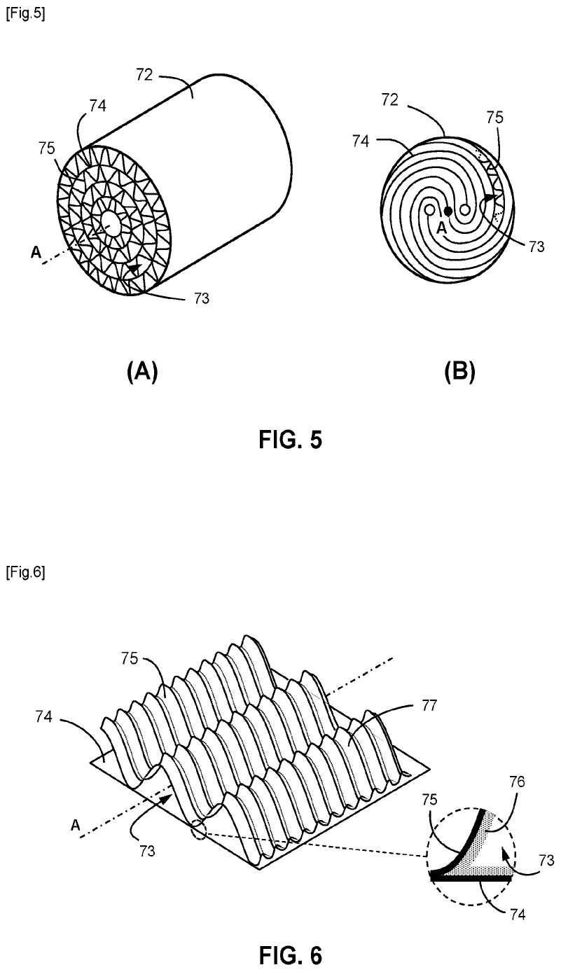

FIG. 5 is, in (A) a perspective view of another embodiment of a block of the adsorbent; and in (B) a transverse view of yet another embodiment of a block of the adsorbent; in the gas treatment device of a gas turbine test bench according to the invention.

FIG. 6 is an illustration of a portion of a variant of an embodiment of a block of the adsorbent of FIG. 4(B).

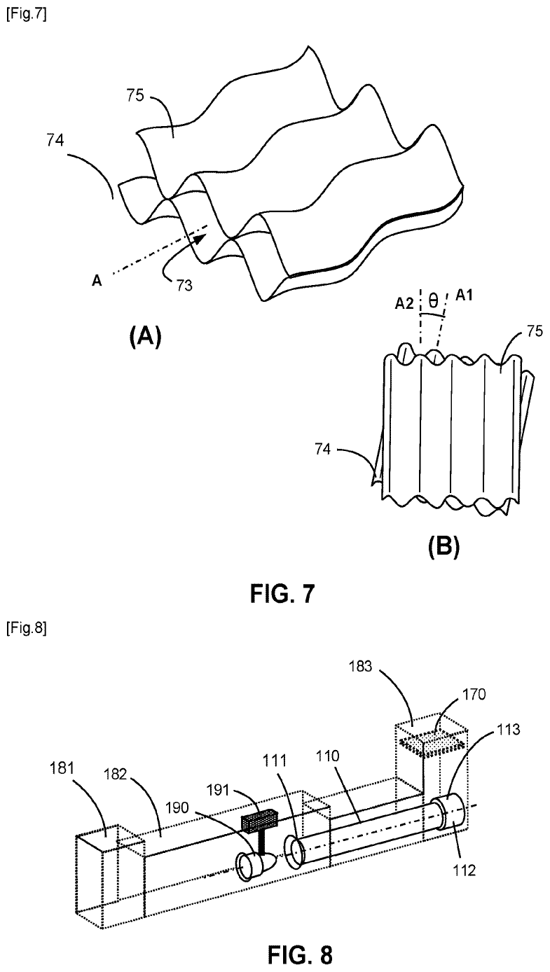

FIG. 7 is, in (A), an illustration of a portion of yet another embodiment of a block of the adsorbent; and in (B) an illustration of a portion of yet another embodiment of a block of the adsorbent; in the gas treatment device of a gas turbine test bench according to the invention.

FIG. 8, already described, is a perspective view of a turbomachine test bench according to the prior art.

FIG. 9, already described, is a side view of the upstream part of the turbomachine test bench of FIG. 8.

### DETAILED DESCRIPTION OF THE INVENTION

In the description below, the terms “upstream” and “downstream” are defined with respect to the normal direction of flow of gas and air in the test bench, in the gas turbine and in the exhaust duct during normal operation of the invention.

The invention is described below in the case where the gas turbine is a turbomachine and where the test bench is a testing bench, but applies to any gas turbine and any type of test. The invention is described below in the case where the pollutant gas is carbon dioxide gas CO₂, but applies to any pollutant gas (e.g. Sox, Nox) and pollutant particles.

FIG. 1 shows a turbomachine test bench 90 according to the invention. This test bench 80 comprises a building 88 which comprises, from upstream to downstream (in the normal direction of air flow during operation of the turbomachine 90) an inlet stack 81, a test hall 82 and an exhaust stack 83. The air enters the test hall 82 through the vertical inlet stack 81, which is open to the outside at its inlet. The test hall 82 comprises a turbomachine 90 which is mounted on a thrust balance 91 and which is intended to be tested.

When the turbomachine 90 is operating (i.e. during a period when the turbomachine is running (for example, this period corresponds to the time of a test)), there are three air flows that circulate in the test hall 82:
the primary flow (FP), which passes through the combustion chamber (HP (high-pressure) core) of the turbomachine 90 and participates in combustion. This primary FP flow is therefore at the discharge loaded with carbon dioxide but also with water, Sox, Nox and other pollutant particles.
the secondary flow (FS), which is compressed by the fan of the turbomachine 90 and which generates the majority of the thrust. This secondary flow FS initially circulates around the primary flow FP.
the induced air flow (FI), which is sucked by the negative pressure at the outlet of the turbomachine 90. In fact, the engine flow, the sum of the primary flow FP and the secondary flow FS, entering the external tube 10, causes, by jet pump effect, a so-called “induced” flow that circulates in the test hall 82 without passing through the turbomachine 90. This induced flow FI initially circulates around the secondary flow FS.

These three air flows constitute the gas flow displaced by the turbomachine 90. This displaced gas flow passes through the exhaust stack 83 and then exits the building 88. This displaced gas flow passes through a carbon-dioxide gas treatment device 70 which is intended to treat this carbon-dioxide gas and which is included in the test bench 80. For example, this treatment device 70 is located in the building 88. This treatment device 70 captures the carbon-dioxide gas so that the gas flow exiting this treatment device 70 has the least possible load of carbon-dioxide gas, i.e. this gas flow is depolluted. For example, this carbon dioxide gas treatment device 70 is located in the exhaust stack 83 or just above (at the downstream outlet) the exhaust stack on the path of the gas flow moved downstream of the turbomachine 90, as illustrated in FIG. 1. This capture of the carbon dioxide gas takes place during the passage of the gas flow displaced in the treatment device 70. Non-limitatively, the time of this capture corresponds to the operating time of the turbomachine 90 during a test of this turbomachine 90. Alternatively, the time of this capture is slightly longer than this operating time.

Alternatively, as illustrated in FIG. 2, the carbon dioxide gas treatment device 70 includes a duct which is connected upstream to the outlet of the exhaust stack 83, and which includes the adsorbent 71 at its downstream end. The displaced gas flow therefore passes in this duct leaving the exhaust stack 83 and then passes through the adsorbent 71. The adsorbent 71 rests on the floor, which facilitates its assembly and inclusion in the treatment device 70. The gas flow passes through the adsorbent 71 in an essentially horizontal direction.

The carbon dioxide gas treatment device 70, which is located downstream of the turbomachine 90 on the path of the gas flow displaced by this turbomachine 90, constitutes a first treatment device that is part of the test bench 80. In fact, the test bench 80 may comprise one or more other treatment devices, called second treatment device 60, which is located upstream of the turbomachine 90. This second treatment device 60 will be described below.

According to the invention, the (first) carbon-dioxide gas treatment device 70 includes a solid adsorbent 71 which is intended to capture the carbon-dioxide gas molecules. This carbon-dioxide gas treatment device 70 is illustrated in FIG. 1 and in FIG. 2. The solid adsorbent 71 consists of a modular block 72, or a plurality of modular blocks 72, one of which is illustrated. The invention is described below in the case where the solid adsorbent consists of a plurality of blocks 72. These blocks 72 are joined together by their lateral faces. The blocks 72 therefore all extend along the same longitudinal direction. This longitudinal direction is substantially the direction in which the displaced gas flow passes through the blocks 72. In FIG. 4(A) and 4(B), each block 72 has a rectangular (for example square) cross-section such that the blocks 72 are all contiguous (i.e. there is no space between any two adjacent blocks 72). The blocks 72 may have cross sections of other geometries for which the assembly is optimal: hexagonal cross-section, triangular cross-section, cross-section with concave and convex walls that fit together. Each block 72 has a plurality of channels 73 whose walls are absorbent and in which the displaced gas flow is able to flow. Each block 72 is divided into channels 73 by the walls of these channels 73 so that there is no space between these channels 73.

FIG. 4(A) illustrates the carbon dioxide gas treatment device 70 according to the invention, the solid adsorbent 71 and the blocks 72 that make it up. For example, the adsorbent 71 has a parallelepipedal shape and consists of the parallelepipedal blocks 72 touching through their lateral faces and disposed in the same plane. The blocks 72 therefore form a single layer. FIG. 4(B) shows an isolated block 72, with the channels 73 passing through it from one face to the opposite face. FIG. 4(A) illustrates the adsorption phenomenon, wherein the carbon-dioxide gas molecules (shown schematically by black particles) that are present in the downstream flow are adsorbed in the surfaces of the walls of the channels 73. Thus, the gas emerging from the adsorbent 71 downstream essentially comprises molecules other than carbon dioxide gas (these molecules are shown schematically by white particles).

The central curve of a channel 73 is defined as the line passing through the centers of the cross-sections of this channel 73 (a cross-section is perpendicular to the longitudinal direction of this channel, which is the direction in which it extends). In general, these central curves are curved. The main axis A of a channel 73 is then defined as the tangent to the central curve of the channel 73 at the upstream end of the channel 73. For example, the channels 73 are straight. In this case, the central curve of a channel 73 is a straight line which is coincident with the main axis A of the channel 73, which is called the central straight line.

For example, the two central curves of any two channels 73 are parallel, i.e. any normal to one of these central curves is a normal to the other of these central curves. Parallel channels 73 are then spoken of. In the case where the channels 73 are straight, this means that the central straight lines of the channels 73 are all parallel.

Advantageously, the main axis A of each channel 73 is oriented according to the flow direction of the displaced gas flow. This situation is shown in FIG. 4(B) and FIG. 4(C), where the flow direction of the displaced gas flow is represented by arrows.

Each channel 73 has a cross-section. For example, the cross section is polygonal, i.e. this cross section is formed by a polygon. For example, this polygon is a square, a rectangle, or a triangle. Alternatively, the cross section is curvilinear, i.e. the section is formed by a curve without an angular point. For example, this curve is an ellipse or a circle. Alternatively, the cross-section is formed consisting of a curvilinear part and a polygonal or rectilinear part. For example, the cross-section is formed by a straight segment and a curve that extends this segment at two angular points. This variant is illustrated in FIG. 4(B) and FIG. 4(C) in the case where this curve is a substantially sinusoidal arch.

Advantageously, the blocks 72 consist of substrates (74, 75) formed as channels 73 and of a porous adsorbent material 76 that covers these substrates (74, 75). For example, these substrates (74, 75) are metallic. For example, these substrates (74, 75) are manufactured from metal sheets. This metal is for example steel or an alloy of FeCrAl.

For example, the metallic substrates consist of first flat or curved sheets 74 and second corrugated sheets 75 which are alternately stacked and in point contacts such that each second sheet 75 is sandwiched between two first sheets 74. Thus, each channel 73 is delimited by a portion of first sheet 74 and by an arch of a second sheet 75 that touches the first sheet 74 along two lines parallel to the main axis A of the channel 73.

According to one embodiment illustrated in FIG. 4(B) and FIG. 4(C), each block 72 is a tube of rectangular cross-section, for example of square cross-section, the first sheets 74 of this block 72 are flat, each second corrugated sheet 75 being sandwiched between two first sheets 74 and in point contact with them. FIG. 4(C) also illustrates the adsorption phenomenon in a channel 73, wherein the carbon dioxide gas molecules (black particles) that are present in the downstream stream are adsorbed in the adsorbent material 76 that covers the first sheet 74 and the second sheet 75. The first sheet 74 and the second sheet 75 covered with adsorbent material 76 thus form the walls of the channel 73. Thus, the gas emerging from the adsorbent 71 downstream essentially comprises molecules (white particles) other than carbon dioxide. The transverse plane P shows in transparency the adsorbent material 76 which covers the first sheet 74 and the second sheet 75.

According to another embodiment illustrated in FIG. 5(A), each block 72 is a tube and the first sheets 74 of the block 72 are shaped as tubes coaxial with this tube. Each second sheet 75 being corrugated between two first sheets 74 over a full circumference. Thus, a first sheet 74 and a second sheet 75 in point contact with this first sheet 74 form channels 73.

According to another embodiment, each block 72 is a tube and surrounds a single first sheet 74 which is shaped in a spiral. A second single sheet 75 extends corrugated between the layers of this first sheet 74. Thus, this first sheet 74 and this second sheet 75 form separate channels 73.

According to yet another embodiment illustrated in FIG. 5(B), each block 72 is a tube and surrounds the first sheets 74 which are shaped in spirals that form S. Each second sheet 75 being corrugated between two first sheets 74. A portion of a second sheet 75 is illustrated. FIG. 5(B) is a view of the block 72 in a transverse plane such that the main axis A (represented by a black dot) is perpendicular to the plane of the page. Thus, a first sheet 74 and a second sheet 75 in contact with this first sheet 74 form separate channels 73.

Advantageously, the walls of the channels 73 have reliefs 77 that generate turbulence in the flow of gas that flows in these channels 73. Consequently, the adsorption of the carbon dioxide in the channels 73 is more efficient. For example, the first sheets 74 and/or the second sheets 75 have reliefs 77. FIG. 6 illustrates an example of these reliefs. The second sheets 75 have substantially sinusoidal corrugations in the direction of the main axis A of each channel 73 over the entire length of each channel 73. These corrugations therefore constitute these reliefs 77. The first sheets 74 do not have any corrugations. Alternatively, the first sheets 74 have corrugations, for example identical to the corrugations of the second sheets 75. FIG. 6 also illustrates an enlargement of the portion of a channel 73 surrounded by a dashed circle (in a transverse plane perpendicular to the main axis A). This enlargement shows the deposition of adsorbent material 76 on the first sheet 74 and on the second sheet 75.

According to other embodiments of the invention, the metallic substrates consist of first corrugated sheets 74 and second corrugated sheets 75 which are stacked alternately and in point contacts such that each second sheet 75 is sandwiched between two first sheets 74. These embodiments are less costly than embodiments with flat sheets 75 because all sheets 74 and 75 are identical. In addition, the pressure drop through the channels 73 is reduced.

In a first of these other embodiments, illustrated in FIG. 7(A), in perspective, the first corrugated sheets 74 and the second corrugated sheets 75 are identical and are corrugated both in the transverse direction (perpendicular to the main axis A) and along the main axis A of each channel 73. Thus, each channel 73 is corrugated in the direction of its main axis A. Each channel 73 therefore has a central curve which is corrugated in the direction of its main axis A.

In a second of these other embodiments, illustrated in FIG. 7(B) in a plan view, the first corrugated sheets 74 and the second corrugated sheets 75 are identical. Each sheet (74, 75) is corrugated in its main plane only in the transverse direction and thus forms straight parallel passages. The main axis of each of the channels of a first sheet 74 is oriented along a first main axis A1 and the main axis of each of the channels of a second sheet is oriented along a second main axis A2. The main planes of the first sheets 74 and second sheets 75 are parallel to a plane P, perpendicular to the plane of FIG. 7(B). The first sheets 74 are offset in their main plane with respect to the second sheets 75 by a small angle θ, for example between 2° and 10°. This variant has the advantage of introducing turbulence in the flow circulating in the channels 73 and thus promoting adsorption.

Advantageously, the thickness of the metallic sheets (74, 75) is less than 100 microns, which increases the ratio of the open surface of the block 72 to its total cross-sectional area. The open surface of a block 72 is defined as the material-free surface in a cross-section of this block 72. For example this thickness is less than 50 microns. For example, this thickness is between 20 microns and 30 microns.

To increase the adsorption capacity of the adsorbent 71, the number of channels 73 in a block 72 of a given cross-section can be increased. For example, the channel density 73 is greater than 155 channels/cm² (1000 channels/in² (channels per square inch)), for example greater than 190 channels/cm² (1200 channels/in²), for example greater than 250 channels/cm² (1600 channels/in²).

Advantageously, the adsorbent material 76 of the blocks 72 is a porous material that is a metal-organic framework (MOF). These materials have a covalent structure of ordered mesoporous or microporous hybrid crystals that are created from the reaction between organic molecules and metal ions. These structures are ultraporous (high porosity greater than 1000 m² per gram), allowing them to store a greater amount of gas than conventional porous solids with lower porosity.

For example, this adsorbent material 76 is of the SIFSIX class or is of the MOF-74 class.

The layer of adsorbent material 76 has a thickness between 5 and 30 microns, for example between 10 and 20 microns.

The first advantages of the adsorbent block 72 of the invention when the walls of the blocks 72 consist of metallic substrates (74, 75) covered with a porous adsorbent material 76 are provided by this adsorbent material 76, which has
a rate of adsorption of the carbon dioxide gas between 5 and 30 times faster than zeolite 13X, allowing a high capture efficiency even with high gas velocities and a shorter length of block 72,
a carbon dioxide gas storage capacity at least equal to that of zeolite 13X and which remains high even at high temperature (>65° C.),
improved carbon dioxide gas/water selectivity, in particular in the case of the use of a MOF-74 class material.

These first advantages are a reduction in both the cross-sectional surface area of a block 72 (in particular due to a higher gas velocity) and its longitudinal length (along its main axis A) due to the high storage capacity of the retained material, stability in the capture performance after several adsorption/desorption cycles, a regeneration energy that remains twice as high as for an amine absorption process in aqueous solution.

The second advantages of the adsorbent block 72 of the invention are provided by the nature of the substrate (74, 75) and are as follows:
the selection of a metallic substrate on which the adsorbent material 76 is deposited, rather than a ceramic substrate or a matrix made of extruded or 3D-printed material, makes it possible to considerably reduce the wall thicknesses to a few tens of microns as against several hundred microns. Thus, by reducing the thicknesses of material between the channels 73 of a block 72, it is possible, for a given density of channels 73, to increase the open surface area of a block 72 beyond 70%, for example up to 90% of the surface area of a total cross-section of the block 72. This results in a reduction, for the same block size 72, of the resistance to the flow of gas.
furthermore, reducing the thickness of the substrate allows a deposition of materials with a thickness of a few tens of microns to ensure a greater carbon dioxide gas retention capacity, always with an acceptable pressure loss and volume of the block 72.
on the one hand, the metallic substrate has a lower specific thermal capacity than other materials, which makes it possible not to store the heat emitted during gas adsorption, and on the other hand a higher thermal conductivity, which makes it possible to heat up quickly during desorption, for example. Conversely, a ceramic substrate cannot withstand rapid heating and can crack.

The third advantages of the adsorbent block 72 of the invention are provided by the structure of this block 72. This is because the use of corrugated sheets 75 of low thicknesses makes it possible to significantly increase the number of channels (up to 190 channels/cm² or more as against 100 channels/cm² typically for ceramic blocks), which significantly increases the adsorption surface of a channel 73, which increases the carbon dioxide gas retention capacity for the same volume of a block 72.

According to a variant illustrated in FIG. 3, the test bench 80 comprises a second carbon dioxide gas treatment device 60 which is located upstream of the turbomachine 90. For example, this second treatment device 60 is located at the upstream end of the inlet stack 81. For example, alternatively or in addition, this second treatment device 60 is located between the inlet stack 81 and the test hall 82. In this case, this second treatment device 60 may be located upstream and/or downstream of acoustic baffles (not shown) which are located in the test hall 82 upstream of the turbomachine 90. This second treatment device 60 helps to depollute the gas flow before it enters the turbomachine 90.

Since the turbomachine 90, during its operation, generates a gas flow in the building 88, an additional suction system, separate from the turbomachine, is not necessary. However, in a variant, the building 88 includes an additional suction system that contributes to circulating this gas flow.

The invention also relates to a method for producing a test bench 80 for a gas turbine 90 which comprises a building 88 as described above, this method comprising the following steps:
(a) a modular block 72 is constructed which has a plurality of channels 73 the walls of which are adsorbent.
(b) If applicable, step (a) is repeated in order to construct a plurality of the modular blocks 72, the modular block(s) 72 constituting an adsorbent 71, with which a pollutant-gas treatment device 70 is formed.
(c) The pollutant-gas device 70 is arranged in the test bench 80 such that the gas flow which is displaced by said gas turbine 90 in operation and which flows as far as the exhaust stack 83 is able to flow in the channels 73.

For example, step (a) includes a step (a1) where an adsorbent material 76 is deposited on a metallic substrate (74, 75) and a step (a2) where the metallic substrate (74, 75) is conformed to form the plurality of channels. Step (a1) is performed before or after step (a2). Advantageously, in all cases in step (a), a support or a guide is used by means of which the metallic substrates (74, 75) are positioned in order to form a block 72. This is because, since the metallic substrates (74, 75) are thin, they are fragile and must be handled with care.

For example, the adsorbent material is deposited on the metallic substrate (74, 75) by one of the following coating methods, which are particularly suitable for deposits in small channels (less than a millimeter for example) over a certain length (for example several tens of centimeters) which presents a difficulty:

A first method is “slurry coating” (called “slurry method”), which consists in depositing a powder/binder suspension on the part to be treated, in this case the metallic substrate, then by a thermal cycle, to decompose the slurry and diffuse the deposited element.

A second method is sol-gel deposition (abbreviation of solution-gel) by dip-coating (dipping-drawing), which is a method for producing materials enabling the synthesis of glasses, ceramics and organic-mineral hybrid compounds, from precursors in solution.

A third method is cathodic electrophoresis, also called “cataphoresis”, which is an electrochemical deposition process. The metallic substrate to be coated is immersed in a bath of conductive aqueous solution and, under the effect of a direct current applied to this substrate, which is conductive and forms the cathode, a layer of organic solution is deposited on the substrate.

Advantageously, step (a) has a step (a3) after step (a1), or more generally immediately before step (b), during which the uniformity of the thickness of the coating in the future longitudinal direction is checked, and, if necessary, this deposition is adjusted or recommenced in order to obtain satisfactory uniformity.

With regard to step (b), in an embodiment described above, the blocks 72 are assembled by their lateral walls in the same transverse plane to form a layer of blocks 72, This layer then constitutes the adsorbent 71.

In another embodiment in step (b), several of these layers are formed and then these layers are aligned along the longitudinal direction in order to constitute the adsorbent 71. Since the walls of the blocks 72 are thin, these blocks 72 are fragile and handling these blocks 72 is tricky. Advantageously, a support or a guide is used by means of which the layers of blocks 72 are positioned in order to align them exactly and without gaps between these layers. Thus, it is easier to construct a longer-length adsorbent 71. This length can be several tens of centimeters or even more than one meter. Reinforcement may also be added to these blocks 72 in order to rigidify the adsorbent 71 and prevent it from deforming.

What is claimed is:

1. Gas turbine test bench comprising a building that includes an air inlet stack at a first end of the building and a gas exhaust stack at a second end of the building, a test hall containing said gas turbine intended to be tested, and at least one pollutant-gas treatment device capable of treating said gas stream that is displaced by said gas turbine in operation and which goes as far as said exhaust stack, wherein said pollutant-gas treatment device comprises a solid adsorbent which comprises at least one modular block having a plurality of channels the walls of which are adsorbent and in which said displaced gas flow is able to flow.

2. Test bench for a gas turbine according to claim 1 such that said at least one block comprises metallic substrates formed to form said channels and a porous adsorbent material that covers said substrates.

3. Test bench for a gas turbine according to claim 2, such that said adsorbent material is a metal-organic framework.

4. Test bench for a gas turbine according to claim 1, such that at least two of said channels are parallel and such that their main axis A is oriented, at the upstream end of said channels, in the flow direction of the displaced gas flow.

5. Test bench for a gas turbine according to claim 1, such that each of said channels has a cross-section selected from a polygonal cross-section and a curvilinear cross-section.

6. Test bench for a gas turbine according to claim 1, such that the surface area of the open cross-section of said at least one block is greater than or equal to 70% of the surface area of the total cross-section of said at least one block.

7. Test bench for a gas turbine according to claim 1, such that said treatment device includes a duct that is connected to said exhaust stack downstream of said exhaust stack and such that said adsorbent rests directly on the floor.

8. Test bench for a gas turbine according to claim 1, such that it includes a second pollutant-gas treatment device which is located upstream of said gas turbine.

9. Test bench for a gas turbine according to claim 1, such that it is devoid of a suction system of said displaced gas stream separate from said gas turbine.

10. Method for producing a gas turbine test bench which comprises a building which comprises an air inlet stack at a first end of the building and a gas exhaust stack at a second end of the building and a test hall containing said gas turbine intended to be tested, said method comprises the following steps:
(a) a modular block is constructed which has a plurality of channels the walls of which are adsorbent;
(b) if necessary, step (a) is repeated in order to construct a plurality of said modular blocks, said at least one block constituting an adsorbent with which a pollutant-gas treatment device is formed; and
(c) said pollutant-gas device is arranged in said test bench such that the gas flow which is displaced by said gas turbine in operation and which flows as far as said exhaust stack is able to flow in said channels.

11. Method according to claim 10, such that, in step (b), said adsorbent comprises a plurality of said blocks which are disposed in a transverse plane perpendicular to the flow direction in said blocks to form a layer, this arrangement being repeated to form a plurality of layers, said layers being aligned in said flow direction to form said adsorbent.
